(19) United States
(12) Patent Application Publication
(10) Pub. No.: US 2003/0167347 A1
(43) Pub. Date: Sep. 4, 2003

(54) Home network printer adapter

(76) Inventors: James Lee Combs, Lexington, KY (US); William Henry Reed, Lexington, KY (US)

Correspondence Address: TAYLOR & AUST, P.C., 12029 E. Washington Street, Indianapolis, IN, 46229, US

(21) Appl. No.: 10/074,477

(22) Filed: Feb. 11, 2002

(51) Int. Cl. G06F 15/16

(52) U.S. Cl. 709/250; 710/64; 710/15

(57) ABSTRACT

A computer network includes at least one host computer, at least one peripheral device, and a microprocessorless network adapter interconnecting the at least one host computer and the at least one peripheral device.

### BACKGROUND OF THE INVENTION

1. Field of the Invention

The present invention relates to a network adapter, and, more particularly, to a network adapter for a printer.

2. Description of the Related Art

Personal computers used in business are usually interconnected on a network to enable sharing of information and system resources. High-performance printers on the network may be shared at a lower total cost than if personal printers were attached to each computer. Printers may be attached to network computers, to a network server, or directly to the network through a network adapter.

Due to cost and a multiplicity of network designs, printers seldom directly support attachment to a network. Instead, a network adapter may be selected that provides functionality unique to the type of network hardware and network operating system. An external network adapter (ENA) connects by cable to a standard port (for example: parallel, serial, USB, Firewire) on the printer. Alternatively, the printer may be designed to incorporate an internal network adapter (INA) as an electronic card that plugs into the printer controller board. The advantage of an external adapter is that a common printer design can be attached either to a personal computer at minimal cost or to the network through an adapter.

While standards continue to evolve, high-speed Ethernet, 10/100 baseT on category 5 twisted pair cable terminating in RJ-45 jacks has become the leading personal computer network hardware. Cable is a reliable and high-speed connection, but running new cable in a home is expensive and inconvenient.

While ubiquitous in business, personal computer networks have been uncommon in the home. The cost of the computer network adapters, hubs, and cable installation is difficult to justify, and a homeowner seldom has the advanced skills needed for network configuration and administration. Where multiple computers exist, files are easily transferred on diskette, and personal printers are priced so low that each computer can have its own printer without sharing.

The advent of broadband Internet access on cable modems and asynchronous digital subscriber modem (ADSL) phone modems is driving new interest in home networks. These modems typically output data using an Ethernet interface. An Ethernet card is installed in a first computer by the service provider. If the homeowner wants to provide broadband Internet access to a second computer, installing a home network is preferred to leasing a second access line. The number of home networks in the U.S. is expected to grow rapidly—for example, from less than 2 million in 1999 to over 10 million in 2002. While some customers will install traditional Ethernet cable systems similar to those used for years in business, new solutions unique to the home environment are expected to be more common.

Responding to customer desire to avoid installing Ethernet cable, alternate solutions were developed including networks that operate wirelessly or over existing home wiring for powerline or phoneline. Phoneline networks appear to be the most popular, with several vendors providing kits for about $130 containing PC adapter cards, network software, and cables to connect to any convenient telephone outlet. Phoneline products that follow version 2 of the Home Phoneline Networking Alliance (HomePNA) specification support 10 megabits per second (mbps) data rates and are certified for interoperability. With low-priced, high-speed, reliable networks products that are easily installed, home networks are expected to grow rapidly. The proliferation of these new home networks opens the opportunity for invention of new printer solutions—inventions that are more appropriate for small home networks. In particular, there is a need for adapters that enable direct connection of printers and other service devices to wireless and phoneline networks.

Universal Serial Bus (USB) is a high-speed (12 mbps) standard initially supported in WINDOWS 98 and the APPLE iMac for connection of peripherals to personal computers. USB cables have a host (A) connector on the system side and a client (B) connector on the peripheral side. Many consumers are reluctant to open their computer case to install adapter cards, so USB has become a leading means for installation of aftermarket system enhancements including scanners, drives, digital cameras, and printers. The traditional parallel port remains the most common means to connect printers to a computer, but USB, which is faster and uses a smaller cable, has become more common. USB adapters may be found that attach to the network and to the computer host USB port.

What is needed in the art is an improved low cost network adapter for peripherals.

### SUMMARY OF THE INVENTION

The present invention provides an adapter device configured for attaching peripherals directly to common home networks. Specific protocols are provided on both sides (network and peripheral) of the device, and unique firmware is provided that bridges the interfaces and meets system requirements for network addressing and peripheral hosting. A functional subset of network attachment simplifies design and reduces costs.

The invention comprises, in one form thereof, a computer network including at least one host computer, at least one peripheral device, and a microprocessorless network adapter interconnecting the at least one host computer and the at least one peripheral device.

The invention comprises, in another form thereof, a computer network including at least one host computer, at least one USB peripheral device, and a network adapter interconnecting the at least one host computer and the at least one USB peripheral device. The network adapter receives and stores status information from the at least one USB peripheral device.

An advantage of the present invention is that, while the primary application of the invention is as an External Network Adapter (ENA) printer adapter, the same device could also be used to attach other peripherals such as drives, scanners, or digital cameras to the home network.

Another advantage is that direct attachment of peripheral devices on a home network allows greater flexibility in locating the devices.

Yet another advantage is that direct attachment of peripheral devices on a home network allows the devices to be addressed by networked computers without powering-on a computer attached to the peripheral.

A further advantage is that with peripheral devices being directly attached to a home network, the peripheral devices do not need to occupy space around the computer.

A still further advantage is that a microprocessor, with its associated high cost, may not be needed in the network adapter.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein

FIG. 1 is a block diagram of a network including one embodiment of a home network ENA printer adapter of the present invention; and

FIG. 2 is a block diagram of another network including the home network ENA printer adapter of FIG. 1.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

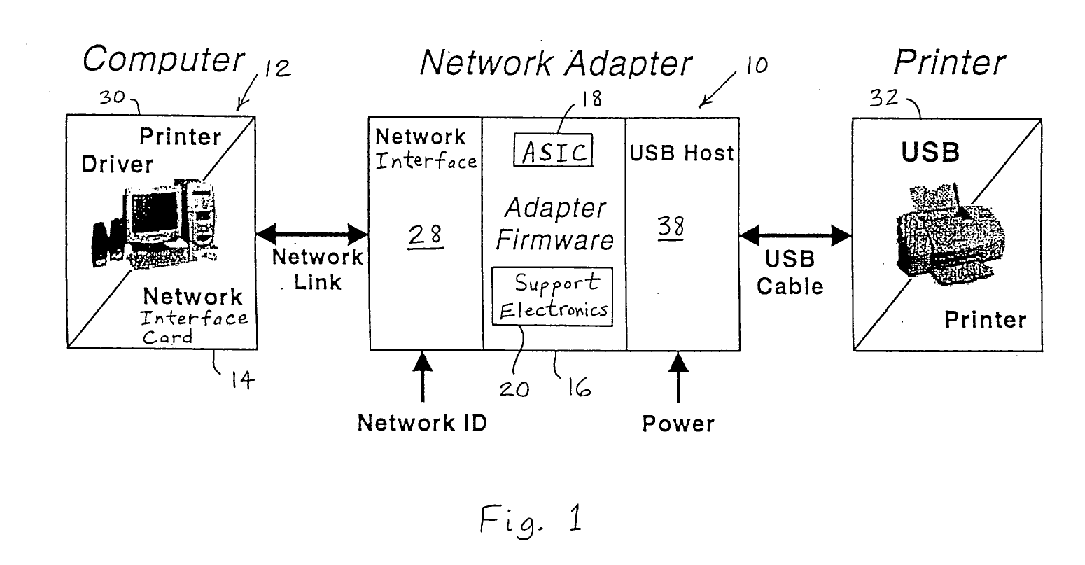

Referring now to the drawings, and more particularly to FIG. 1, there is shown a hardware and firmware configuration for a peripheral device network adapter 10. In this embodiment, adapter 10 provides USB host (A connector) support for USB enabled printers and direct attachment to one or more of these common home networks: Ethernet (RJ-45 connector); HomePNA (RJ-11 connector); wireless (antenna); and HomePlug (AC Line Cord). The computer 12 includes a network interface card (NIC) 14 which generally supports various protocols, such as Transmission Control Protocol/Internet Protocol (TCP/IP), Netware, AppleTalk and User Datagram Protocol (UDP). Some protocols, such as TCP/IP, are more sophisticated and require a reply from a receiving device, while other protocols, such as UDP, do not. It is possible for the network interface of the present invention to support only UDP, thereby further simplifying its design and reducing its cost. While the embodiment described in detail herein is directed to USB connectivity, it is to be understood that the present invention is applicable to other connectivity schemes as well.

The electrical components required to establish appropriate communication interfaces of each type are well known and reference designs are available. Firmware in the adapter ties the two interfaces together, provides device address identity to the network, and provides host control to attached USB clients.

The adapter firmware 16 contains several microcode modules that execute communications and data management tasks. These tasks include, for example: device identification, media access control, device status reporting and tracking, data stream management, USB host management, and power management. All of these code modules might be integrated into one or more electronic modules or application specific integrated circuits (ASIC's) 18. Thus, the Ethernet network adapter 10 with host USB function can include ASIC's 18 and support electronics 20 without requiring a microprocessor. That is, the peripheral device network adapter 10 can be microprocessorless.

### Device Identification

In the embodiment of FIG. 1, the adapter 10 identifies itself to other devices on the local network by responding to discovery queries with a device identity number. For example, a unique number may be programmed into each adapter as a final step of manufacture, and the number is printed on a label on the adapter. A unique number is required so that multiple adapters can be used on the same network. This method of device identity limits adapter access to computers on the same local network—a limitation that is acceptable for home networks and allows simplification and cost reduction. For Internet and enterprise networks, an adapter is expected to support protocols where the device can adopt device identity and address assigned by the network.

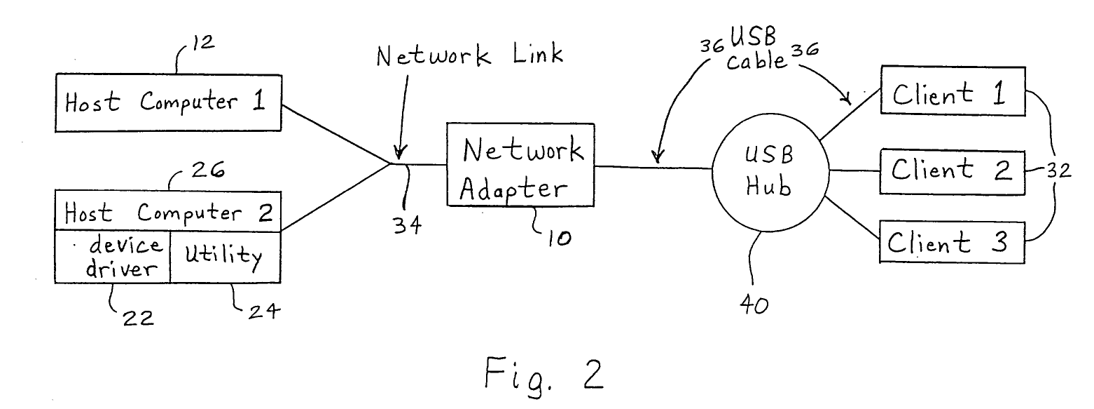

The peripheral device network adapter 10 uses, for example, internet protocol addressing. The internet protocol address(es) are assigned by a device driver 22 (FIG. 2) or utility 24 operating on a host computer 26 remotely attached to the network.

ASIC 18 performs automatic USB enumeration without software. Enumeration includes determining what devices are on the network and assigning addresses. A “device attached” signal from ASIC 18 indicates the presence of a device, such as printer 32, and indicates that a USB channel on USB cable 36 is available for use to the attached device. ASIC 18 can notify printers 32 during enumeration that network adapter 10 is not a personal computer and needs to be updated of any status changes within printers 32. This feature makes use of the fact that a vendor-specific USB command can be sent by a printer 32 over USB cable 36 immediately following the enumeration process.

It is not necessary to know the type of printer 32 in order to enumerate the USB bus. Once enumerated, ASIC 18 provides a high speed 8-bit parallel bi-directional interface to printer 32 over USB cable 36.

Enumeration of the printer class of USB devices by ASIC 18 is as follows:

Issue a USB “Reset”

Issue a USB “Get Device Descriptor”

Issue a USB “Reset”

Issue a USB “Set Address”

Issue a USB “Get Device Descriptor”

Issue a USB “Get Configuration Descriptor”

Issue a USB “Set Configuration”

Issue a USB “Vendor Specific Request”-SET_PROTOCOL

Get a “Cache Update”

The last two steps of issuing a USB vendor-specific request and getting a cache update is needed for an ENA. This allows adapter 10 to know the status of printer 32 so it can reply to a “HBN Status Request” via the network.

### Media Access Control (MAC)

Firmware 16 in the adapter 10 manages the network interface 28. The MAC code module can work with any of several physical connections that support the IEEE 802 protocols including: 10/100baseT Ethernet, HomePNA, 802.11 wireless Ethernet, and others. The hardware (chips, connectors, crystals. magnetics, etc.) supported by the MAC is standard and available from a variety of sources. New code might be written for the MAC, but a variety of code modules are commercially available that might be selected for incorporation into the present invention.

### Data Stream Management

Home networks do not require the same degree of administration as a business network, so the present invention need not meet all the standards for network protocol and can be optimized for the desired tasks. For example, to utilize adapter 10, driver software 30 is installed in each computer on the network, and the network adapter 10 can be configured to only respond to commands from that driver software 30. However, the network adapter can respond to multiple computers on the local network with such driver software 30 installed. In this way, costs can be minimized and the configuration simplified.

The present invention operates on the assumption that device drivers 22 on network computers incorporate a sub-system that communicates with the firmware 16 in the adapter 10. In a standalone configuration, device drivers 22 take control of a system port on the computer operating system and communicate directly to peripherals over a communication link attached to the system port. In a network configuration, additional tasks are added to the device driver 22 to manage the packets of data sent and received from the peripheral 32 over the network link 34.

The network adapter 10 of the present invention contains firmware 16 that complements the communications subsystem in the device driver 22 on the host network computer and provides logic to interpret commands and to process data. Once a particular transaction is initiated, this firmware module accepts or rejects data packets received over the network. The firmware module passes on to the peripheral 32 data that is expected and in the correct order, and rejects data that is either from other sources or out of sequence until the transaction is completed.

The peripheral device firmware adapter 10 may be capable of detecting and processing inbound data before passing the processed data on to client devices 32. For example, the adapter 10 detects that a printer data stream contains portable document format (PDF) or joint photographic experts group (JPEG) files that are processed into data suitable for printing by a client printer 32. Similarly, data in an Apple Macintosh file format could be converted to Disc Operating System (DOS) file format before being sent on to a client storage device. This function is bi-directional. A raw data file from a client scanner could be compressed into a standard image file format before sending on for storage on a host computer attached to the network.

In one embodiment, the adapter 10 contains all the code needed to support a variety of printers and other devices. However, in other embodiments the adapter has only a basic code set and additional code can be transferred to flash memory in the adapter during an installation process. The additional code might provide updates to the basic code set or provide unique function to support features of the attached peripheral 32.

### Device Status Reporting and Tracking

Some peripherals 32 are designed to be controlled by a single host computer or to communicate bi-directionally with the host computer. To facilitate such control on the network, provision is made to store in the adapter device 10 any information provided by the peripheral 32 to the computer 10 or required by the peripheral 32 from the host. Firmware 16 in the adapter 10 makes this information (such as printer status, cartridge information, drop counts, and error messages) available to any computers on the network, and the adapter 10 manages print commands from multiple computers. Some of this information may be stored in non-volatile random access memory (NVRAM) on the printer or other peripheral, but for faster recovery and to support devices without such storage, this information is cached in the network adapter 10.

The peripheral device network adapter 10 receives and stores device status information from a USB client peripheral, e.g., a printer 32, which periodically sends status data to the adapter 10. In response to a status request from a compatible device driver 22 or utility 24 operating on a host computer 26 attached to the network, the adapter 10 sends stored device status information to the remote host computer 26.

In another embodiment, the adapter creates and stores device information instead of accepting data from the client device. Thus, additional function not found in the client peripheral device is provided in the adapter. Examples of such function include the ability to record power-on time, count pages printed, track supply usage, record usage by a host computer, etc. These and other classes of information about the networked peripheral can be retrieved by a compatible device driver or utility operation on a remote host computer attached to the network.

### USB Host Management and Power Management

A Universal Serial Bus is a popular and standard high-speed device for attaching peripherals to personal computers. In one embodiment, the network adapter of the present invention attaches to peripherals via a USB cable 36, but any of a variety of other links are also possible within the scope of the present invention.

In the case of USB connection, there are additional tasks that are the responsibility of the hosting device that are not required for a USB client device. USB hosting is usually the responsibility of a computer operating system (like WINDOWS 98), but this function can be emulated in the firmware of a special purpose appliance. This or similar code in the present invention manages the link between the adapter and the peripheral.

USB hosts 38 also are obligated to supply limited power to USB clients over the USB cable 36. For this purpose, and to power the adapter, power is supplied from a battery or an external supply. The firmware 16 in the network adapter 10 is capable of providing and managing power. A low-power or sleep mode can be incorporated into the power management routine.

The peripheral device network adapter 10 manages power on client peripheral devices, such as printers 32, by sending a command to the client device to go into a low-power sleep mode until the adapter 10 detects inbound data on the network bound for the client device 32. At this time, the adapter 10 sends a wake-up command to the printer 32 and verifies the active status of the printer 32 before accepting the inbound data.

### Multiple Device Support

While the adapter 10 of the present invention can be used to attach printers 32 directly to a network, the adapter 10 also enables support of other peripheral devices such as data storage devices (zip drives, compact disc read/write drives, etc.), image capture devices (scanners, cameras, etc.), and other computer peripherals. For purposes of economy and simplicity, the network adapter 10 supports multiple peripherals including multiple printers (for example, a color printer and a monochrome laser printer).

The adapter 10 of the present invention is capable of supporting multiple peripheral ports if each port has a distinct identification on the network. In such a multi-port embodiment, data stream management firmware in the adapter 10 parses commands and data packets according to the target identification code included in the data stream. In this way, the adapter 10 can manage multiple requests from the same or different hosts on the network to communicate to any available peripheral device.

In the embodiment described above, the peripheral device network adapter 10 has USB host functionality, i.e., the adapter 10 meets the standard requirements for a USB host. The adapter supports multiple peripheral USB client devices when the client devices are attached to the adapter though the USB hub 40. Each client device has a unique network address, for example, an internet protocol address. The adapter 10 routes data to and from the attached USB client devices 32 by using the unique network addresses. It is contemplated, however, that the principles of the invention may be applied to other communication protocols.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A computer network, comprising:
at least one host computer;
at least one peripheral device; and
a microprocessorless network adapter interconnecting said at least one host computer and said at least one peripheral device.

2. The network of claim 1, wherein said network adapter is configured to meet standard requirements for a Universal Serial Bus (USB) host.

3. The network of claim 2, further comprising a USB hub interconnecting said at least one peripheral device and said network adapter.

4. The network of claim 3, wherein said at least one peripheral device comprises a plurality of peripheral devices, said adapter being configured to support said plurality of peripheral devices.

5. The network of claim 4, wherein each said peripheral device has a unique network address.

6. The network of claim 5, wherein each said unique network address comprises a unique internet protocol address.

7. The network of claim 6, further comprising a remotely attached host computer including one of a device driver and a utility, each said unique internet protocol address being assigned by said one of a device driver and a utility.

8. The network of claim 5, wherein said adapter is configured to route data to and from said peripheral devices using said unique network addresses.

9. The network of claim 1, wherein said adapter is configured to manage power on said at least one peripheral device.

10. The network of claim 1, wherein said adapter is configured to send said at least one peripheral device at least one command to go into a low-power sleep mode until said adapter detects inbound data bound for said at least one peripheral device.

11. The network of claim 1, wherein said adapter is configured to at least one of send a wake-up command to said at least one peripheral device and verify an active status of said at least one peripheral device before accepting the inbound data.

12. The network of claim 1, wherein said adapter is configured to perform automatic USB enumeration.

13. The network of claim 12, wherein said enumeration is performed without software.

14. A network adapter comprising:
at least one application specific integrated circuit; and
support electronics,
wherein said adapter is microprocessorless.

15. The adapter of claim 14, wherein said adapter is configured to meet standard requirements for a Universal Serial Bus (USB) host.

16. The adapter of claim 14, wherein said adapter is configured to interconnect at least one peripheral device and at least one host computer.

17. The adapter of claim 14, wherein said adapter is configured to:
detect inbound data;
process the inbound data; and
pass the processed data to at least one peripheral device.

18. The adapter of claim 14, wherein said application specific integrated circuit is configured to perform automatic USB enumeration.

19. The adapter of claim 18, wherein said enumeration is performed without software.

20. A computer network, comprising:
at least one host computer;
at least one USB peripheral device; and
a network adapter interconnecting said at least one host computer and said at least one USB peripheral device, said network adapter being configured to receive and store status information from said at least one USB peripheral device.

21. The network of claim 20, wherein said at least one USB peripheral device comprises at least one printer.

22. The network of claim 20, wherein said at least one USB peripheral device is configured to periodically send the status information to said adapter.

23. The network of claim 20, wherein said at least one host computer includes at least one of a device driver and a utility, said at least one of a device driver and a utility being configured to send a status request to said adapter.

24. The network of claim 23, wherein said adapter is configured to send the stored status information to said at least one host computer in response to said status request.

25. The network of claim 20, further comprising a USB interface between said adapter and said at least one USB peripheral device.

26. A computer network, comprising:
at least one host computer;
at least one USB peripheral device; and
a network adapter interconnecting said at least one host computer and said at least one USB peripheral device, said network adapter being configured to create and store information regarding a status of said at least one USB peripheral device.

27. The network of claim 26, wherein said adapter is configured to record a power-on time.

28. The network of claim 26, wherein said adapter is configured to count a number of pages printed.

29. The network of claim 26, wherein said adapter is configured to track supply usage.

30. The network of claim 26, wherein said adapter is configured to record usage by said at least one host computer.

31. The network of claim 26, wherein said at least one host computer includes at least one of a device driver and a utility, said at least one of a device driver and a utility being configured to retrieve said status information.
